(19) United States
(12) Patent Application Publication
(10) Pub. No.: US 2026/0219766 A1
(43) Pub. Date: Jul. 30, 2026

(54) METHOD, APPARATUS, DEVICE, AND MEDIUM FOR PROVIDING FEEDBACK

(71) Applicant: Beijing Zitiao Network Technology Co., Ltd., Beijing (CN)

(72) Inventor: Yujian Kang, Beijing (CN)

(21) Appl. No.: 19/170,058

(22) Filed: Apr. 4, 2025

Related U.S. Application Data
(63) Continuation of application No. PCT/CN2025/075489, filed on Jan. 27, 2025.

(51) Int. Cl. G06F 3/0484; G06N 20/00

(52) U.S. Cl. CPC G06F 3/0484; G06N 20/00

(57) ABSTRACT

A method, an apparatus, a device, and a medium for providing feedback are provided. In a method, a media item is provided in an application. In response to determining an interaction between an object in the application and the media item, an association degree between the object and the media item is determined based on object information of the object and media information of the media item. In response to determining that the association degree satisfies a predetermined association condition, a feedback control is provided in the application, and the feedback control is configured to provide a feedback for the media item in the application.

### CROSS REFERENCE

This application is a continuation of and claims priority to PCT Application No. PCT/CN2025/075489, filed on Jan. 27, 2025, and entitled “METHOD, APPARATUS, DEVICE, AND MEDIUM FOR PROVIDING FEEDBACK”, the disclosure of which is incorporated herein by reference in its entirety.

### FIELD

Implementations of the disclosure generally relate to application management, and in particular, to a method, an apparatus, a device, and a computer-readable storage medium for providing feedback in an application.

### BACKGROUND

An application may provide a variety of media items, a user in the application may interact with the media item, and provide feedback such as a comment and the like to the media item. For example, the application may provide a comment control, and various users in the application may actively press the comment control to post a comment. In a process of viewing the media item, the need for user expression to express a feedback for the media item is increasing, and it is desirable to provide the feedback in the application in a more efficient manner.

### SUMMARY

In a first aspect of the disclosure, a method for providing feedback is provided. In the method, a media item is provided in an application. In response to determining an interaction between an object in the application and the media item, an association degree between the object and the media item is determined based on object information of the object and media information of the media item. In response to determining that the association degree satisfies a predetermined association condition, a feedback control is provided in the application, and the feedback control is configured to provide a feedback for the media item in the application.

In a second aspect of the disclosure, an apparatus for providing feedback is provided. The apparatus includes: a providing module configured to provide a media item in an application; a determining module configured to determine, in response to determining an interaction between an object in the application and the media item, an association degree between the object and the media item based on object information of the object and media information of the media item; and a feedback module configured to provide a feedback control in the application in response to determining that the association degree satisfies a predetermined association condition, the feedback control being configured to provide a feedback for the media item in the application.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a computer-readable storage medium having stored thereon a computer program which, when executed by a processor, causes a processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the contents described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an implementation of the disclosure;

FIG. 2 shows a block diagram for providing feedback according to some implementations of the disclosure;

FIG. 3 shows a block diagram of providing a feedback control in an application according to some implementations of the disclosure;

FIG. 4 shows a block diagram of providing comments in an application according to some implementations of the disclosure;

FIG. 5 shows a block diagram of providing a plurality of feedback controls in an application according to some implementations of the disclosure;

FIG. 6 shows a block diagram for determining an association degree according to some implementations of the disclosure;

FIG. 7 shows a block diagram of a method for determining and deploying a machine learning model according to some implementations of the disclosure;

FIG. 8 shows a block diagram of a method for providing feedback using a machine learning model according to some implementations of the disclosure;

FIG. 9 shows a flowchart of a method for providing feedback according to some implementations of the disclosure;

FIG. 10 shows a block diagram of an apparatus for providing feedback according to some implementations of the disclosure; and

FIG. 11 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

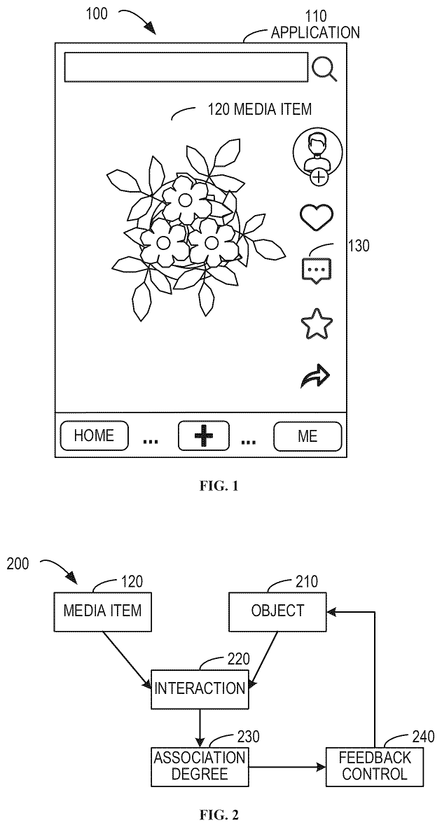

The application may provide a variety of media items, a user in the application may make various interactions with the media item, and provide feedback, such as comments, to the media item. An application environment of the disclosure is described with reference to FIG. 1, FIG. 1 shows a block diagram 100 of an application environment according to an implementation of the disclosure. As shown in FIG. 1, a media item 120 may be provided to an object in an application 110 (e.g., a user of the application 110), and the media item 120 may include multiple types, including, but not limited to, video, short video, music, text, images, games, or rich media data including combinations of the above multiple types. For ease of description, the video is described as an example of the media item in the context of the disclosure. The application may provide a comment control 130, and respective objects in the application may actively press the comment control to post a comment. In a process of viewing the media item, the need for user expression to express a feedback for media items is increasing, and at this time, it is desirable to provide the feedback in the application in a more efficient manner.

### Summary of Providing Feedback

In order to at least partially solve the deficiencies in the related art, a method for providing feedback is proposed according to an implementation of the disclosure. In summary, the feedback control may be automatically provided in the application upon determining that a user is interested in the media item and desires to provide a feedback. In this way, an interaction between the user and the application may be simplified, and the efficiency of using the application may be improved. A summary according to an implementation of the disclosure is described with reference to FIG. 2, and FIG. 2 shows a block diagram 200 for providing feedback according to some implementations of the disclosure. The media item 120 may be provided in the application, and an interaction 220 between the media item 120 and an object 210 in the application may be determined. In response to determining that there is the interaction 220, an association degree 230 between the object 210 and the media item 120 may be determined based on object information of the object 210 and media information of the media item 120. Here, the association degree 230 may represent a degree of interest of the object 210 for the media item 120, and may reflect whether the object 210 is to provide the feedback such as a comment for the media item 120 to some extent.

Further, in response to determining that the association degree 230 satisfies a predetermined association condition (e.g., above a predetermined threshold), a feedback control 240 may be provided in the application for providing a feedback for the media item in the application. At this time, when it is found that the object 210 is more interested in the media item 120 and it is likely to submit a feedback, the feedback control may be automatically provided in the application. In this way, the object 210 may directly invoke the feedback control to provide a feedback. In this way, the feedback control may be provided at an appropriate time point, reducing the complexity of interaction and improving the performance of the application.

### Detailed Process for Providing Feedback

Having described a summary according to some implementations of the disclosure, more details regarding a method for providing feedback will be described below. According to some implementations of the disclosure, an interaction between an object and a media item may include multiple types, e.g., an object viewing a media item, an object viewing comments of other objects for a media item, an object viewing information of a publisher of a media item, an object collecting a media item, an object giving a like to a media item, an object forwarding a media item, an object downloading a media item, and/or the like. For ease of description, more details of the disclosure are provided below by way of example only where an object viewing a media item is taken as an interaction between the object and the media item.

For example, when it is determined that the object views the media item, it may be determined that there is an interaction, and then an association degree between the object and the media item may be determined. According to some implementations of the disclosure, in the process of determining the association degree between the object and the media item, the association degree may be determined immediately when it is found that the object starts to view the media item. Alternatively and/or additionally, the association degree between the object and the media item may be determined in response to determining that a time length of the interaction satisfies a predetermined time condition. In this way, whether the object is really interested in the media item may be determined in a more accurate manner, thereby presenting the feedback control at a more accurate time point. As another example, it may be determined that the object is interested in the media item and desires to know more content of the media item in response to determining that the object drags a playback progress bar of the media item, replays the media item, or fast-forwards the media item.

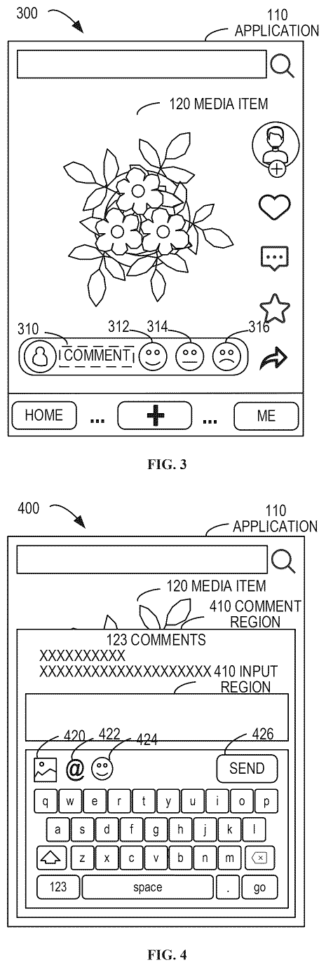

According to some implementations of the disclosure, in response to receiving the interaction with the feedback control, a feedback for the media item is provided in the application. FIG. 3 shows a block diagram 300 of providing a feedback controls in the application according to some implementations of the disclosure. As shown in FIG. 3, a quick feedback control may be provided at a lower portion (or other location) of the interface of the application 110. Specifically, the feedback control 310 may be configured to input a comment, and the feedback control 312, 314, and 316 may be configured to provide an icon comment to publish a quick comment. With some implementations of the disclosure, the feedback control may be automatically provided at an appropriate time point, thereby reducing the complexity of user operation.

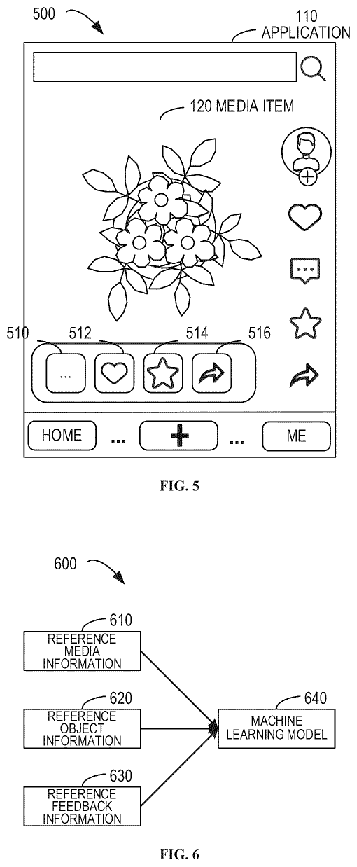

According to some implementations of the disclosure, in the processing of providing the feedback for the media item in the application, an input region for inputting the feedback may be provided in the application; the feedback corresponding to an interaction with the input region is presented in the input region in response to receiving the interaction; and the feedback is provided in the application in response to receiving a confirmation for the feedback. In response to determining that an interaction between the object and the feedback control 310 in FIG. 3, an interface as shown in FIG. 4 may be provided, FIG. 4 shows a block diagram 400 of providing comments in an application according to some implementations of the disclosure.

As shown in FIG. 4, a comment region 410 may be provided in the application 110. The comment region may display a historical comment of the media item 120, for example, there are 123 historical comments. Further, an input region 410 may be provided in the application 110 for the user to input a comment. Alternatively and/in or additionally, a control 420 for inputting an image may be provided in the application 110, a “@” control 422 for “referring to” other objects, a control 424 for inputting an icon, and the like. The user may input data to the input region 410 using a keyboard, and in response to detecting a confirmation for the input data (e.g., an interaction with a control 426), a comment may be provided in the application. With some implementations of the disclosure, the feedback control may be automatically provided at a more suitable time point, thereby reducing the operational complexity of the application.

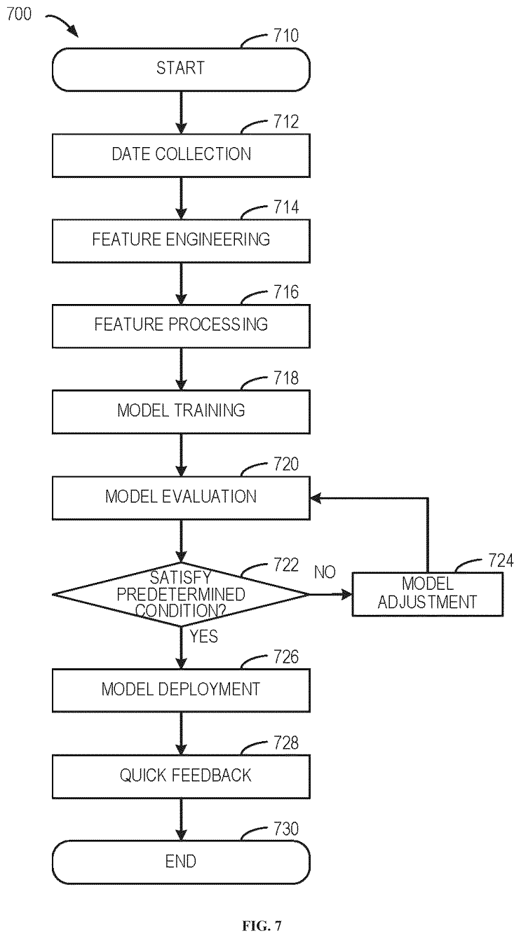

It should be understood that although the details of providing the feedback control are described above with only an example in which a comment serves as the feedback, alternatively and/or additionally, the feedback may include at least one of: commenting, forwarding, collecting for the media item, and following a provider of the media item. More details are described with reference to FIG. 5, FIG. 5 shows a block diagram 500 of providing a plurality of feedback controls in an application according to some implementations of the disclosure. As shown in FIG. 5, at least one feedback control may be presented in the application 110. For example, a feedback control 510 may be configured to provide a comment function, a feedback control 512 may be configured to provide a like function, a feedback control 514 may be configured to provide a collection function, a feedback control 516 may provide a forwarding function, and so on. With some implementations of the disclosure, multiple feedback functions may be provided at appropriate time points in a more convenient and efficient manner, thereby simplifying the operation complexity of the application.

According to some implementations of the disclosure, a machine learning model may be used to determine an association degree between an object and a media item. Specifically, in the process of determining the association degree between the object and the media item, a machine learning model describing the association degree between the object and the media item may be obtained; and the association degree between the object and the media item is determined based on object information of the object and media information of the media item by using the machine learning model. With some implementations of the disclosure, the machine learning model may be utilized to obtain knowledge about whether a user is about to provide a comment from sample data, thereby determining whether a feedback control is to be provided in a more accurate manner.

According to some implementations of the disclosure, in the process of determining the machine learning model, a reference sample, also referred to as a training sample, may be obtained. FIG. 6 shows a block diagram 600 for determining a machine learning model according to some implementations of the disclosure. The reference sample may include, for example, reference media information 610 of a reference media item provided in a reference application, reference object information 620 of a reference object interacting with the reference media item, and reference feedback information 630 representing a reference feedback provided by the reference object for the reference media item. The machine learning model is determined using the reference media information, the reference object information, and the reference feedback information. Here, the reference media item may represent a historical media item provided in the reference application.

Specifically, the reference object information may include, but is not limited to, a viewing duration indicating a time length that the object views the media item; a rate of playing completion of the media item indicating a proportion that the object completely views the media item; a number of likes indicating a number of likes from the object for the media item; a number of times of forwarding indicating a number of times that the media item is forwarded by the object; a number of comments indicating a number of times that the object is commented on the media item; a usage time length indicating a time length that the object uses the application; an activeness indicating a time length that the object watches the video each day, a quantity of watched videos, and the like; a device parameter such as a type of an electronic device used by the object, an operating system, and the like. Alternatively and/or additionally, the media information of the reference media item may include, but is not limited to, a content type, for example, music, sports, news, and the like; a publishing time, for example, a time point in a day, a time point in a week, or the like; a number of views indicating a number of times the media item is viewed; a time length indicating a time length of the media item, and the like. Further, the reference sample may include annotation information about whether the object provides a feedback for the media item, that is, reference feedback information. In the case of commenting, 0 may be used to indicate that no comment is provided and 1 may be used to indicate that a comment is provided.

Further, the machine learning model 640 may be trained with a large amount of collected sample data in order to extract relevant knowledge about whether the object is about to comment on the media item. According to some implementations of the disclosure, the machine learning model may be established based on a regression model. The regression model may take the feature as an input, and output a probability that the user clicks on the quick comment. A goal of model training is to find a suitable decision boundary, so that the model may predict whether the user will click the quick comment according to an input feature. The performance of the model is evaluated by using a method such as cross validation, and the accuracy and generalization ability of the model are ensured. The trained model may be deployed and the probability that the user clicks the quick comment is predicted in real time, and the quick comment function is triggered according to the prediction result. Here, the output of the model may be a probability value between 0 and 1, indicating the likelihood that the user clicks on the quick comment.

According to some implementations of the disclosure, Formula 1 may be used as a loss function of the machine learning model, for example.

$$P ( y = 1 \vert x ) = \frac{1}{1 + {e}^{- ( {β}_{0} + {β}_{1} {x}_{1} + {β}_{2} {x}_{2} + … + {β}_{n} {x}_{n} )}} \qquad Formula 1$$

In Formula 1, x may represent the input feature, for example, represented as n dimensions (x₁, x₂, . . . , xₙ₋₁), including features related to the media information and the object information; and parameters β₀, β₁, . . . , βₙ represent parameters of the machine learning model. In the training process, features determined based on the reference media information and the reference object information may be input into the machine learning model, and a prediction y may be determined using the machine learning model. Then, the parameters of the machine learning model may be updated in a direction that minimizes a difference between the prediction y and the reference feedback information (i.e., a true value). With some implementations of the disclosure, the machine learning model may be enabled to obtain knowledge about an object, a media item, and whether a feedback is provided, thereby supporting determining whether to provide a quick feedback control to the object in a more accurate manner. The trained machine learning model may output a probability of the object providing a feedback, which may be represented, for example, with a numerical value between [0, 1].

It should be understood that the training process is described only with an example of whether to provide a comment as tag data, alternatively and/or additionally, the tag data may include a time at which the object provides a feedback, e.g., how long the object provides the feedback after viewing the media item. In this way, the machine learning model may provide a more accurate prediction, and the machine learning model may output a time point that provides the feedback control, e.g., 10 seconds, 15 seconds, or other time point after the object views the media item. In this way, prematurely providing a feedback control may be avoided to disturb normally browsing the media item.

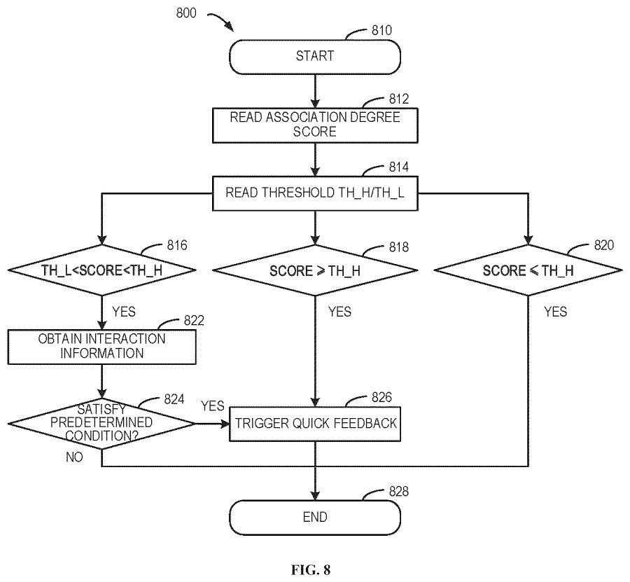

More details on the machine learning model are described with reference to FIG. 7, and FIG. 7 shows a block diagram of a method 700 for determining and deploying a machine learning model according to some implementations of the disclosure. As shown in FIG. 7, the method 700 starts at block 710. At block 712, data may be collected, e.g., a large number of reference samples may be collected over a past period of time. At block 714, it may be determined which features are extracted from the reference samples. At block 716, feature processing may be performed and desired features are extracted. At block 718, the machine learning model may be trained, e.g., the machine learning model may be updated based on the loss function shown in Formula 1 as shown above. At block 720, the updated machine learning model may be evaluated. At block 722, if it is determined that the updated machine learning model satisfies a predetermined condition, e.g., reaches a predetermined accuracy, or reaches a predetermined number of updates, and so on. If a result at block 722 is YES, the method 700 proceeds to block 726 to deploy the machine learning model. Alternatively and/or additionally, if the result at block 722 is “No”, the machine learning model 724 may be adjusted and the adjusted machine learning model may be again evaluated. At block 728, a quick feedback function may be provided using the deployed machine learning model, and the method 700 ends at block 730.

According to some implementations of the disclosure, the machine learning model may be deployed at a server of the application, and alternatively and/or additionally, the machine learning model may be deployed at a client device running the application. It may be determined whether to provide the feedback control in the application based on the association degree from the machine learning model. According to some implementations of the disclosure, the predetermined association condition may include at least one threshold. For example, an upper threshold may be provided. Specifically, in the process of providing the feedback control in the application, in response to determining that the association degree is higher than the upper threshold (for example, denoted as TH_H), a feedback control is provided in the application. For example, the upper threshold may be set as 0.5, 0.6, or another value, for example. If it is determined that the association degree is higher than or equal to the upper threshold, the feedback control is directly provided in the application. In this way, the feedback control may be provided in a more rapid and efficient manner, thereby supporting the user to make a quick feedback.

According to some implementations of the disclosure, a lower threshold (for example, denoted as TH_L) may be provided, in the process of providing the feedback control in the application, in response to determining that the association degree is lower than the upper threshold and higher than the lower threshold, interaction information between the object and the media item may be obtained; and in response to determining that the interaction information satisfies a predetermined presentation condition, the feedback control is presented in the application. Here, the lower threshold may be set as 0.3, 0.25, or another value, for example. If it is determined that the association degree is lower than the lower threshold, no feedback control is provided. If it is determined that the association degree is between the lower threshold and the upper threshold, there may be an uncertain factor at this time, and it is necessary to further determine whether to present the feedback control based on the interaction information.

According to some implementations of the disclosure, the interaction information may include multiple types, for example, a time length that a user views a media item, a user replaying a media item, a user giving a like to a media item, a user forwarding a media item, a user playing a media item with a full screen, and/or the like. If it is determined that the time length exceeds a predetermined threshold (e.g., 30 seconds, or other numerical value), the feedback control may be presented. Alternatively and/or additionally, the feedback control may be presented if a positive interaction operation between a user and a media item is determined, such as replaying a media item, giving a like to a media item, forwarding a media item, playing a media item with a full screen, or the like. Alternatively and/or additionally, if a negative interaction operation between a user and a media item is determined, for example, stopping playing a media item, exiting a media item, etc., presentation of the feedback control is prohibited. In this way, it may be determined whether the user is about to submit a comment in a more accurate manner, thereby reducing the risk that the feedback control interferes with the user.

FIG. 8 shows a block diagram of a method 800 for providing a feedback using a machine learning model according to some implementations of the disclosure. As shown in FIG. 8, the method 800 starts at block 810. At block 812, an association degree (e.g., denoted as SCORE) may be read. At block 814, the upper threshold TH_H and the lower threshold TH_L may be read. Then, SCORE, TH_H, TH_L may be compared. At block 818, if it is determined that SCORE≥TH_H, the method 800 may proceed to block 826 to provide a feedback control. At block 820, if the SCORE≤TH_L is determined, the feedback control is disabled and the method 800 ends at block 828. At block 816, if it is determined that TH_L≤SCORE≤TH_H, the method 800 may proceed to block 822 and obtain interaction information. At block 824, if the interaction information satisfies a predetermined condition, the method 800 proceeds to block 826 and provides a feedback control. If the interaction information does not satisfy the predetermined condition, the method 800 proceeds to block 828 and ends. With some implementations of the disclosure, the upper threshold and the lower threshold may provide a two-stage determination strategy to determine whether to provide the feedback control in the application in a more accurate manner.

According to some implementations of the disclosure, the same threshold may be set for multiple objects of an application. In this way, a large number of objects of an application may be managed, thereby reducing the complexity of application management. Alternatively and/or additionally, multiple objects may be set with their own thresholds, respectively. In this way, different objects may be managed with higher precision and customized services are provided for respective objects.

According to some implementations of the disclosure, interaction information between the object and the feedback control may be obtained; and the predetermined association condition is updated based on the interaction information. For example, if it is found that a certain object likes providing feedbacks, a condition of providing the feedback control may be appropriately relaxed, and the feedback control may be provided more to the object. For another example, if it is found that a certain object does not like to provide a feedback, the condition of providing the feedback control may be tightened appropriately and the feedback control is provided less to the object. Specifically, in the process of updating the predetermined association condition based on the interaction information, in response to determining that the interaction information indicates that the object submits a feedback, the upper threshold is decreased, or the lower threshold is decreased. In this way, the feedback control may be presented more to the object. Alternatively and/or additionally, in response to determining that the interaction information indicates that the object does not submit a feedback, the upper threshold is increased, or the lower threshold is decreased. In this way, the feedback control may be presented less to the object. According to some implementations of the disclosure, a condition for triggering a quick feedback may be customized for different objects, thereby providing a finer customization service for different objects.

According to some implementations of the disclosure, feedback information input by the object may be determined, and a machine learning model (e.g., a recommendation model) for providing the media item to the object is updated based on the feedback information. At this time, the recommendation model may be updated based on whether the object provides a feedback and the specific content of the feedback. In this way, the accuracy of the recommendation model is further improved, thereby improving the efficiency of obtaining the information of interest by the object.

With some implementations of the disclosure, a feedback control may be automatically provided in the application, and an object may directly invoke the feedback control to provide a feedback. In this way, the feedback control may be provided at an appropriate time point, reducing the complexity of interaction and improving the performance of the application.

### Example Processes

FIG. 9 shows a flowchart of a method 900 for providing feedback according to some implementations of the disclosure. At block 910, a media item is provided in an application. At block 920, in response to determining an interaction between an object in the application and the media item, an association degree between the object and the media item is determined based on object information of the object and media information of the media item. At block 930, in response to determining that the association degree satisfies a predetermined association condition, a feedback control is provided in the application, the feedback control is configured to provide a feedback for the media item in the application.

According to some implementations of the disclosure, the method 900 further includes presenting in the application the feedback for the media item in response to receiving an interaction with the feedback control.

According to some implementations of the disclosure, providing the feedback for the media item in the application includes: providing in the application an input region for inputting the feedback; presenting in the input region the feedback corresponding to an interaction with the input region in response to receiving the interaction; and providing the feedback in the application in response to receiving a confirmation for the feedback.

According to some implementations of the disclosure, determining the association degree between the object and the media item includes: obtaining a machine learning model describing an association degree between an object and a media item; and determining the association degree between the object and the media item using the machine learning model based on the object information of the object and the media information of the media item.

According to some implementations of the disclosure, providing the feedback control in the application includes: providing the feedback control in the application in response to determining that the association degree is higher than an upper threshold.

According to some implementations of the disclosure, providing the feedback control in the application includes: obtaining interaction information between the object and the media item in response to determining that the association degree is lower than an upper threshold and is higher than a lower threshold; and presenting the feedback control in the application in response to determining that the interaction information satisfies a predetermined presentation condition.

According to some implementations of the disclosure, determining the association degree between the object and the media item further includes: determining the association degree between the object and the media item in response to determining that a time length of the interaction satisfies a predetermined time condition.

According to some implementations of the disclosure, the machine learning model is obtained by: obtaining reference media information of a reference media item provided in a reference application, reference object information of a reference object interacting with the reference media item, and reference feedback information representing a reference feedback provided by the reference object for the reference media item; and determining the machine learning model using the reference media information, the reference object information, and the reference feedback information.

According to some implementations of the disclosure, the method 900 further includes: obtaining interaction information between the object and the feedback control; and updating the predetermined association condition based on the interaction information.

According to some implementations of the disclosure, the feedback includes at least any of: commenting, forwarding, collecting the media item, and following a provider of the media item.

### Example Apparatus and Device

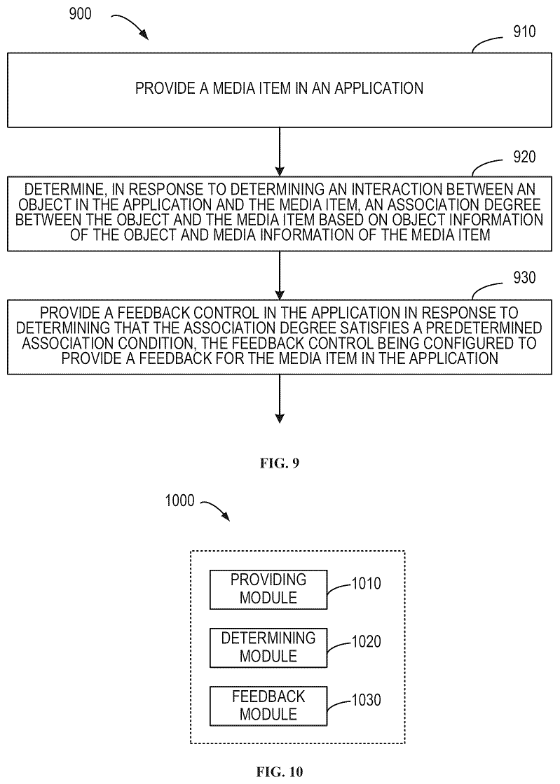

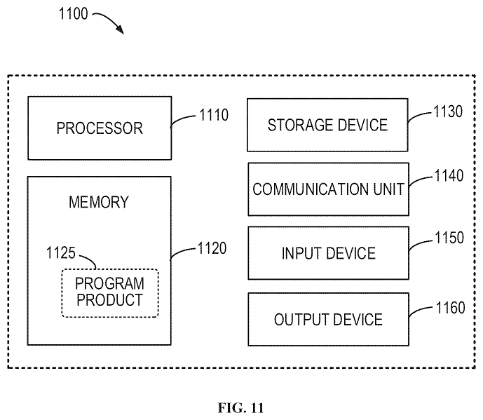

FIG. 10 shows a block diagram of an apparatus 1000 for providing feedback according to some implementations of the disclosure. The apparatus includes: a providing module 1010 configured to provide a media item in an application; a determining module 1020 configured to determine, in response to determining an interaction between an object in the application and the media item, an association degree between the object and the media item based on object information of the object and media information of the media item; and a feedback module 1030 configured to provide a feedback control in the application in response to determining that the association degree satisfies a predetermined association condition, the feedback control being configured to provide a feedback for the media item in the application.

According to some implementations of the disclosure, the apparatus 1000 further includes a presenting module configured to present in the application the feedback for the media item in response to receiving an interaction with the feedback control.

According to some implementations of the disclosure, the presenting module is further configured to: provide in the application an input region for inputting the feedback; present in the input region the feedback corresponding to an interaction with the input region in response to receiving the interaction; and provide the feedback in the application in response to receiving a confirmation for the feedback.

According to some implementations of the disclosure, the determining module is further configured to: obtain a machine learning model describing an association degree between an object and a media item; and determine the association degree between the object and the media item using the machine learning model based on the object information of the object and the media information of the media item.

According to some implementations of the disclosure, the providing module is further configured to: provide the feedback control in the application in response to determining that the association degree is higher than an upper threshold.

According to some implementations of the disclosure, the providing module is further configured to: obtain interaction information between the object and the media item in response to determining that the association degree is lower than an upper threshold and is higher than a lower threshold; and presenting the feedback control in the application in response to determining that the interaction information satisfies a predetermined presentation condition.

According to some implementations of the disclosure, the determining module is further configured to: determine the association degree between the object and the media item in response to determining that a time length of the interaction satisfies a predetermined time condition.

According to some implementations of the disclosure, the machine learning model is obtained by: obtaining reference media information of a reference media item provided in a reference application, reference object information of a reference object interacting with the reference media item, and reference feedback information representing a reference feedback provided by the reference object for the reference media item; and determining the machine learning model using the reference media information, the reference object information, and the reference feedback information.

According to some implementations of the disclosure, the apparatus further includes a processing module configured to: obtain interaction information between the object and the feedback control; and update the predetermined association condition based on the interaction information.

According to some implementations of the disclosure, the feedback includes at least any of: commenting, forwarding, collecting the media item, and following a provider of the media item.

FIG. 11 shows a block diagram of a device 1100 capable of implementing various implementations of the disclosure. It should be understood that a computing device 1100 shown in FIG. 11 is merely illustrative and should not constitute any limitation on the functionality and scope of the implementations described herein. The computing device 1100 shown in FIG. 11 may be configured to implement the method described above.

As shown in FIG. 11, the computing device 1100 is in a form of a general-purpose computing device. Components of the computing device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In a multiprocessor system, the processing units execute computer-executable instructions in parallel to improve the parallel processing capability of the computing device 1100.

The computing device 1100 generally includes a plurality of computer storage media. Such media may be any available media accessible by the computing device 1100, including, but not limited to, volatile and non-volatile media, removable and non-removable media. The memory 1120 may be volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 1130 may be a removable or non-removable medium and may include a machine-readable medium, such as a flash drive, a magnetic disk, or any other medium, which may be capable of storing information and/or data (e.g., training data for training) and may be accessed within the computing device 1100.

The computing device 1100 may further include additional removable/non-removable, volatile/non-volatile storage media/medium. Although not shown in FIG. 11, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 1120 may include a computer program product 1125 having one or more program modules configured to perform various methods or actions of various implementations of the disclosure.

The communications unit 1140 implements communication with other computing devices through a communications medium. Additionally, the functionality of components of the computing device 1100 may be implemented in a single computing cluster or multiple computing machines capable of communicating through a communication connection. Thus, the computing device 1100 may operate in a networked environment using logical connection(s) with one or more other servers, a network personal computer (PC), or another network node.

The input device 1150 may be one or more input devices, such as a mouse, a keyboard, a trackball, or the like. The output device 1160 may be one or more output devices, such as a display, a speaker, a printer, or the like. The computing device 1100 may also communicate with one or more external devices (not shown) as needed, the external device such as a storage device, a display device, etc., communicates with one or more devices that enable a user to interact with the computing device 1100, or communicates with any device (e.g., a network card, a modem, etc.) that enables the computing device 1100 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for providing feedback, comprising:
providing a media item in an application;
determining, in response to determining an interaction between an object in the application and the media item, an association degree between the object and the media item based on object information of the object and media information of the media item; and
providing a feedback control in the application in response to determining that the association degree satisfies a predetermined association condition, the feedback control being configured to provide a feedback for the media item in the application.

2. The method of claim 1, further comprising:
presenting in the application the feedback for the media item in response to receiving an interaction with the feedback control.

3. The method of claim 2, wherein providing the feedback for the media item in the application comprises:
providing in the application an input region for inputting the feedback;
presenting in the input region the feedback corresponding to an interaction with the the input region in response to receiving the interaction; and
providing the feedback in the application in response to receiving a confirmation for the feedback.

4. The method of claim 1, wherein determining the association degree between the object and the media item comprises:
obtaining a machine learning model describing an association degree between an object and a media item; and
determining the association degree between the object and the media item using the machine learning model based on the object information of the object and the media information of the media item.

5. The method of claim 1, wherein providing the feedback control in the application comprises:
providing the feedback control in the application in response to determining that the association degree is higher than an upper threshold.

6. The method of claim 1, wherein providing the feedback control in the application comprises:
obtaining interaction information between the object and the media item in response to determining that the association degree is lower than an upper threshold and is higher than a lower threshold; and
presenting the feedback control in the application in response to determining that the interaction information satisfies a predetermined presentation condition.

7. The method of claim 1, wherein determining the association degree between the object and the media item further comprises:
determining the association degree between the object and the media item in response to determining that a time length of the interaction satisfies a predetermined time condition.

8. The method of claim 4, wherein the machine learning model is obtained by:
obtaining reference media information of a reference media item provided in a reference application, reference object information of a reference object interacting with the reference media item, and reference feedback information representing a reference feedback provided by the reference object for the reference media item; and
determining the machine learning model using the reference media information, the reference object information, and the reference feedback information.

9. The method of claim 1, further comprising:
obtaining interaction information between the object and the feedback control; and
updating the predetermined association condition based on the interaction information.

10. The method of claim 1, wherein the feedback comprises at least any of: commenting, forwarding, collecting the media item, and following a provider of the media item.

11. An electronic device, comprising:
at least one processor; and
at least one memory coupled to the at least one processor and storing instructions for execution by the at least one processor, the instructions, when executed by the at least one processor, causing the electronic device to perform acts comprising:
providing a media item in an application;
determining, in response to determining an interaction between an object in the application and the media item, an association degree between the object and the media item based on object information of the object and media information of the media item; and
providing a feedback control in the application in response to determining that the association degree satisfies a predetermined association condition, the feedback control being configured to provide a feedback for the media item in the application.

12. The electronic device of claim 11, wherein the acts further comprise:
presenting in the application the feedback for the media item in response to receiving an interaction with the feedback control.

13. The electronic device of claim 12, wherein providing the feedback for the media item in the application comprises:
providing in the application an input region for inputting the feedback;
presenting in the input region the feedback corresponding to an interaction with the the input region in response to receiving the interaction; and
providing the feedback in the application in response to receiving a confirmation for the feedback.

14. The electronic device of claim 11, wherein determining the association degree between the object and the media item comprises:
obtaining a machine learning model describing an association degree between an object and a media item; and
determining the association degree between the object and the media item using the machine learning model based on the object information of the object and the media information of the media item.

15. The electronic device of claim 11, wherein providing the feedback control in the application comprises:
providing the feedback control in the application in response to determining that the association degree is higher than an upper threshold.

16. The electronic device of claim 11, wherein providing the feedback control in the application comprises:
obtaining interaction information between the object and the media item in response to determining that the association degree is lower than an upper threshold and is higher than a lower threshold; and
presenting the feedback control in the application in response to determining that the interaction information satisfies a predetermined presentation condition.

17. The electronic device of claim 11, wherein determining the association degree between the object and the media item further comprises:
determining the association degree between the object and the media item in response to determining that a time length of the interaction satisfies a predetermined time condition.

18. The electronic device of claim 14, wherein the machine learning model is obtained by:
obtaining reference media information of a reference media item provided in a reference application, reference object information of a reference object interacting with the reference media item, and reference feedback information representing a reference feedback provided by the reference object for the reference media item; and
determining the machine learning model using the reference media information, the reference object information, and the reference feedback information.

19. The electronic device of claim 11, wherein the acts further comprise:
obtaining interaction information between the object and the feedback control; and
updating the predetermined association condition based on the interaction information.

20. A non-transitory computer-readable storage medium having stored thereon computer instructions that, when executed by a processor, cause the processor to perform acts comprising:
providing a media item in an application;
determining, in response to determining an interaction between an object in the application and the media item, an association degree between the object and the media item based on object information of the object and media information of the media item; and
providing a feedback control in the application in response to determining that the association degree satisfies a predetermined association condition, the feedback control being configured to provide a feedback for the media item in the application.
